(19) United States
(12) Patent Application Publication
(10) Pub. No.: US 2025/0357828 A1
(43) Pub. Date: Nov. 20, 2025

(54) BRUSHLESS ELECTRIC MOTOR FOR A MOTOR VEHICLE

(71) Applicant: Brose Fahrzeugteile SE & Co. Kommanditgesellschaft, Wuerzburg, Wuerzburg (DE)

(72) Inventors: Sahil NALAWADE, Pune (IN); Sourabh PAITANDI, Suri (IN); Yogesh SHINDE, Jalna (IN)

(73) Assignee: Brose Fahrzeugteile SE & Co. Kommanditgesellschaft, Wuerzburg, Wuerzburg (DE)

(21) Appl. No.: 19/208,559

(22) Filed: May 14, 2025

(30) Foreign Application Priority Data
May 14, 2024 (DE) 10 2024 204 465.2

(51) Int. Cl. H02K 11/33; H02K 1/14; H02K 11/00

(52) U.S. Cl. CPC H02K 11/33; H02K 1/14; H02K 11/0094; H02K 2203/03; H02K 2211/03

(57) ABSTRACT

A brushless electric motor for a motor vehicle, including a stator, which has a number of electrical coils, which are distributed to multiple phases, and has an electronic system, which has a DC circuit with two electrical poles. Multiple bridge branches are connected between the poles. Two bridge branches in each case form a bridge pair, and each phase is connected in each case between the bridge branches of one of the bridge pairs. The invention also relates to a motor scooter including a main drive.

This nonprovisional application claims priority under 35 U.S.C. § 119(a) to German Patent Application No. 10 2024 204 465.2, which was filed in Germany on May 14, 2024, and which is herein incorporated by reference.

### BACKGROUND OF THE INVENTION

### Field of the Invention

The invention relates to a brushless electric motor for a motor vehicle. The brushless electric motor has a number of electrical coils, which are distributed to multiple phases. The brushless electric motor also comprises an electronic system, which includes a DC circuit having two electrical poles. The invention further relates to a motor scooter including a main drive.

### Description of the Background Art

Motor vehicles usually include a main drive for propulsion. The latter comprises, for example, an internal combustion engine. If the motor vehicle is a motor scooter, the internal combustion engine is usually compact and designed as a single cylinder, since a power demand is usually less than 10 KW. To increase an efficiency, it is possible to provide the main drive with an electrified design and thus use an electric motor. A noise development is also reduced with the aid of a corresponding electric motor, since the main drive in a motor scooter usually has comparatively little sound damping.

For example, a brush-type commutator motor is used as the electric motor. For design reasons, however, a direct mechanical contact exists between a rotor and a stator, which is why a friction, and thus an increased heat development, occurs. A wear is also elevated. It is possible to use a brushless electric motor as an alternative. The latter usually includes a hollow cylindrical stator arranged in a motor housing, including multiple electrical coils, which are interconnected with each other with the aid of an interconnecting unit to form electrical phases.

The interconnecting unit, which is also referred to as an interconnecting ring, usually includes multiple busbars, which are designed, for example, as stamped-bent parts. They are suitably placed along the end face of the stator, so that the interconnection of the electrical coils is implemented. The electrical contacting of the individual electrical coils with the interconnecting ring usually takes place by means of welding, so that a robust electrical connection is implemented. To avoid a short-circuit and to stabilize the busbars in relation to each other, the busbars are usually overmolded with the aid of a plastic.

An axial overall length of the electric motor is enlarged due to the interconnecting ring. Since the positions established by the welds between the electric coils and the interconnecting ring are comparatively inaccessible, a special machine in needed for this purpose, which increases manufacturing costs. It is also possible that increased transfer resistances prevail in the region of the electrical connection to the electrical coils, which reduces efficiency. it is also necessary to select a comparatively large cross-section of the busbars, so that the electrical losses occurring here are comparatively low. The manufacturing costs and a weight are thus comparatively high. However, if the busbars have a reduced cross-section, an excessive heating occurs in the region of the interconnecting ring. If the electric motor is operated in a comparatively damp environment, water precipitates there during a cooling, which may lead to a corrosion and a premature failure of the electric motor.

### SUMMARY OF THE INVENTION

It is therefore an object of the invention to provide a particularly suitable brushless electric motor for a motor vehicle and a particularly suitable motor scooter, an overall size and/or a failure probability is/are advantageously reduced, an efficiency being suitably increased.

In an example, the brushless electric motor is suitable, in particular provided and configured, to form a constituent of a motor vehicle in the mounted state, which is preferably land-based. The brushless electric motor is advantageously suitable, provided, and configured to be supplied with power by means of a vehicle electrical system of the motor vehicle, which carries, for example, a direct voltage of 12 V, 24 V, or 48 V.

The motor vehicle can be, for example, a passenger car, a truck, or a bus. For example, the brushless electric motor is a constituent of an auxiliary unit, such as an electromotive adjusting drive or an electromotive pump. However, the brushless electric motor is particularly preferably a constituent of a main drive of the motor vehicle. A movement speed of the motor vehicle is set, in particular, depending on a supply of power to the brushless electric motor. In this case, the motor vehicle is advantageously a two-wheel motor vehicle, for example, a bicycle, or particularly preferably a motor scooter, and thus a so-called e-scooter. Alternatively, the brushless electric motor is used in an adjusting drive or other auxiliary drive in the two-wheel motor vehicle.

The brushless electric motor can be a brushless DC motor (BLDC) and advantageously a synchronous motor. The brushless electric motor advantageously includes a motor housing, which is provided, for example, with a hollow cylindrical or pot-shaped design. The motor housing is advantageously manufactured from a metal, such as an aluminum, i.e., pure aluminum or an aluminum alloy.

The brushless electric motor, which is referred to below only as an electric motor, can include a rotor, which is arranged, in particular, in the motor housing. The rotor suitably comprises one or multiple permanent magnets. The rotor is preferably connected to a shaft, which is, in particular, rotatably supported. The rotor is suitably arranged concentrically to the shaft. For example, the shaft is rotatably supported around its axis, which corresponds, in particular, to a rotation axis and, with the aid of which, an axial direction of the brushless electric motor is defined.

The brushless electric motor can include a stator, which comprises a number of electrical coils. For example, all electrical coils are of the same design, or at least groupings thereof are of the same design, which makes manufacturing easier. The electrical coils are advantageously oriented in such a way that their axes are each arranged radially with respect to the possible rotation axis. The electric coils are designed, in particular, in such a way that a magnetic field is generated thereby when power is supplied. Each electrical coil preferably forms one electromagnet, or at least one core or tooth is assigned to the particular electromagnet, which is provided, for example, with the aid of a laminated core. The electrical coils are distributed to multiple phases, which are also referred to as electrical phases. The number of electric coils is advantageously the same for each phase. In particular, an integral multiple of the number of phases of electrical coils is thus present.

The brushless electric motor also can comprise an electronic system, which includes a DC circuit having two poles. In particular, one of the poles is a positive pole and the other is a negative pole, an electrical ground, for example, also being assigned to the negative pole. During operation, the electrical voltage which is used to supply the brushless motor and/or is provided, for example, with the aid of the vehicle electrical system is advantageously present between the two poles. For example, the electronic system comprises a current transformer, with the aid of which the DC circuit is supplied. However, the two poles are particularly preferably led to contacts of a port to which the vehicle electrical system is connected in the mounted state. During operation, the electrical voltage present at the DC circuit is thus predefined externally.

The electronic system can include multiple bridge branches, which are connected between the electrical poles. The two poles are thus electrically contacted with each other by means of each bridge branch, and the bridge branches are preferably electrically connected in parallel to each other. The bridge branches are suitably of the same design. Each bridge branch suitably includes one or multiple semiconductor(s), preferably semiconductor switch(es).

Two bridges in each case form a bridge pair. In each case, two of the bridge branches are thus assigned to each bridge pair, so that the number of bridge pairs corresponds, in particular, to twice the number of bridge branches. In each case, each phase is connected between the bridge branches of one of the bridge pairs. In other words, one of the bridge pairs, and thus two of the bridge branches, is assigned in each case to each phase. There is no assignment of one of the bridge branches to two of the phases. In summary, therefore, the number of bridge pairs is equal to the number of phases, and the number of bridge branches is twice the number of phases. Exactly one of the phases is thus assigned to each bridge branch. As a result, multiple H-shaped bridge circuits are formed with the aid of one of the bridge pairs and one of the phases in each case.

Based on a design of this type, it is possible to supply power to each of the phases separately, so that a comparatively precise regulation of the brushless electric motor is made possible. With the aid of each of the bridge branches, only the electrical current needed to supply power to the assigned phase is carried, which is thus reduced. Due to the reduced electrical currents, electrical conductors having a reduced cross-section may be used, which decreases manufacturing costs and a weight. It is also possible to use comparatively cost-effective components for the individual constituents of the bridge branch, for which reason manufacturing costs are reduced. No interconnecting unit, such as an interconnecting ring, is also necessary, for which reason an overall size and a weight are reduced. The brushless electric motor therefore suitably does not have an interconnecting ring or any other interconnecting unit and is thus without an interconnecting ring.

Due to the reduced electrical currents, electrical losses are decreased, which results in less heating. A condensation of water is thus avoided. A failure probability is therefore reduced. It is also not necessary to produce welds in comparatively inaccessible locations, for which reason manufacturing is simplified. A contact resistance is also reduced, so that an efficiency is improved. In summary, the number of electrical connections to be established is reduced, for which reason fewer electrical losses prevail. The individual current-carrying constituents of the brushless electric motor are also comparatively freely accessible, which makes manufacturing easier. In addition, no shielding with the aid of a possible plastic takes place, so that a cooling is improved. A condensation of water during operation is therefore avoided.

The electrical coils can be produced, for example, from stamped-bent parts. Electrical coils are particularly preferably would from an enameled wire. This is, for example, an aluminum enameled wire or a copper enameled wire. At least some of the electrical coils of each phase are suitably wound from a common enameled wire. These electrical coils are thus formed onto each other and suitably form a single piece with each other. It is therefore not necessary to connect the individual electrical coils of each phase to each other, but instead this takes place directly during the manufacture of the electrical coils. In particular, the electrical coils are wound together. For example, all electrical coils of each phase or only a part thereof are produced from the common enameled wire and thus formed onto each other. At least a number of electrical connections still to be established is thus reduced. For example, the electrical coils of the particular phase are electrically connected in series. However, they are particularly preferably electrically connected in parallel. The portion of the enameled wire situated between two of the electrical coils of the particular phase are thus run against one of the assigned bridge branches, while the two free ends of the enameled wire are run against the remaining bridge branch of the assigned bridge branch. Due to the parallel circuit, the electrical current carried by each of the electrical coils is reduced, so that a load is decreased.

Also, the electrical coils can be constructed by means of a single tooth winding. In particular, one tooth is assigned to each electrical coil, which is wound with the aid of the electrical coil assigned in each case. The teeth wound with the electrical coils are separate from each other prior to be arranged in relation to the stator, which simplifies storage. Manufacturing is also made easier. All electrical coils and the assigned teeth are preferably of the same design, so that equivalent parts may be used. All electrical coils of the particular phase are preferably connected in parallel to each other, so that each terminal of each single tooth winding is run against one of the assigned bridge branches. This makes a manufacturing easier. Alternatively, at least some of the electrical coils are electrically connected in series.

For example, the number of phases is equal to 3, so that the number of bridge branches is equal to 6. The number of components necessary to construct the electronic system is thus comparatively small in order to implement the invention. For example, the number of electrical coils is equal to the number of phases. However, the number of electrical coils, which are also referred to only as coils, is particularly preferably equal to 6, the electrical coils of each phase being electrically connected in series or electrically connected in parallel. Alternatively, the number of electrical coils is equal to 12, two series circuits, each made up of two of the electrical coils, being present, which, in turn, are connected in parallel to each other. A total of four of the electrical coils are thus assigned to each phase.

In an example, the number of electrical coils is equal to 12, the number of phases, however, being equal to 6. Two of the electrical coils are thus assigned to each phase in each case. The number of bridge branches is also equal to 12. Due to the larger number of phases, the electrical current carried by each of the electrical coils as well as the bridge branches is reduced, so that the constituents of the bridge branches may be provided with a comparatively cost-effective design. Due to the larger number of phases, a ripple of the torque provided by the brushless electric motor is also reduced.

For example, each bridge branch can comprise one or multiple diodes. However, each bridge branch is particularly preferably formed with the aid of a series circuit made up of two MOSFETs. The series circuit is run in each case against one of the electrical poles at the end side. A contact point can be formed in each case between the MOSFETs of each series circuit, against which the assigned phase is run on the end side. Due to the two MOSFETs, a supply of power to each of the phases with different flow directions is made possible. If the electrical phase has a parallel circuit of multiple of the electrical coils, each assigned electrical coil is connected, preferably directly, to the contact point. The interconnection to form a parallel circuit thus takes place with the aid of the common electrical contacting of the two assigned contact points. For example, each electrical phase is connected to the assigned contact points by means of welding. For example, an insulation displacement contact or other clamping contact is alternatively present for this purpose, so that no additional machines are necessary to establish the electrical connection.

The stator can be provided with a hollow cylindrical design and suitably arranged concentrically to the possible rotation axis. The stator advantageously surrounds the rotor on the circumferential side. The electronic system, in turn, has, for example, a printed circuit board, with the aid of which the end face of the stator is covered. Since no interconnecting unit is present, a comparatively dense arrangement on the stator is made possible, which shortens an axial overall length of the brushless electric motor.

The bridge branches can be provided with the aid of the printed circuit board. In other words, the bridge branches are at least partially formed, in particular, with the aid of semiconductor switches, which are fastened to a body of the printed circuit board. The printed circuit board suitably comprises multiple printed conductors, with the aid of which an interconnection of the individual bridge branches and/or possible semiconductor switches takes place. A suitable electrical interconnection is thus made possible, based on the printed circuit board, the number of components being reduced. The printed circuit board preferably includes multiple receptacles for the electrical and mechanical fastening and/or contacting of the phases. The receptacles are designed, for example, in the manner of press fits or the like. They are suitably situated on the side of the printed circuit board facing the stator.

The motor scooter can have two wheels, which stand on a road in the state for which it is intended. At least one of the wheels is driven with the aid of a main drive of the motor scooter. The main drive comprises a brushless electric motor having a stator, which includes a number of electrical coils, which are distributed to multiple phases. The brushless electric motor comprises an electronic system, which includes a DC circuit having two electrical poles, between which multiple bridges are connected. Two bridges in each case form a bridge pair, and each phase is connected between the bridge branches of each of the bridge pairs.

The main drive, advantageously the brushless electric motor, is, in particular, suitable, provided, and configured to be supplied with power by a vehicle electrical system of the motor scooter, which carries, for example, a DC voltage of 12 V, 24 V or 48 V, or more than 100 V. A movement speed of the electric vehicle results depending on a supply of power to the brushless electric motor. The brushless electric motor is advantageously a synchronous motor.

The refinements and advantages explained in connection with the brushless electric motor are to be similarly transferred to the motor scooter and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a motor vehicle in the form of a motor scooter, including a main drive, which comprises a brushless electric motor;

FIG. 2 shows a section of the brushless electric motor in a side view, which comprises a stator having multiple electrical coils;

FIG. 3 shows a perspective view of two of the electrical coils, which are formed from a common enameled wire.

FIG. 4 shows a perspective view of an example of one of the electrical coils, which is formed via a single tooth winding;

FIG. 5 schematically shows an interconnection of the electrical coils distributed to multiple phases; and

FIGS. 6 through 8 each schematically show a variant of one of the phases.

### DETAILED DESCRIPTION

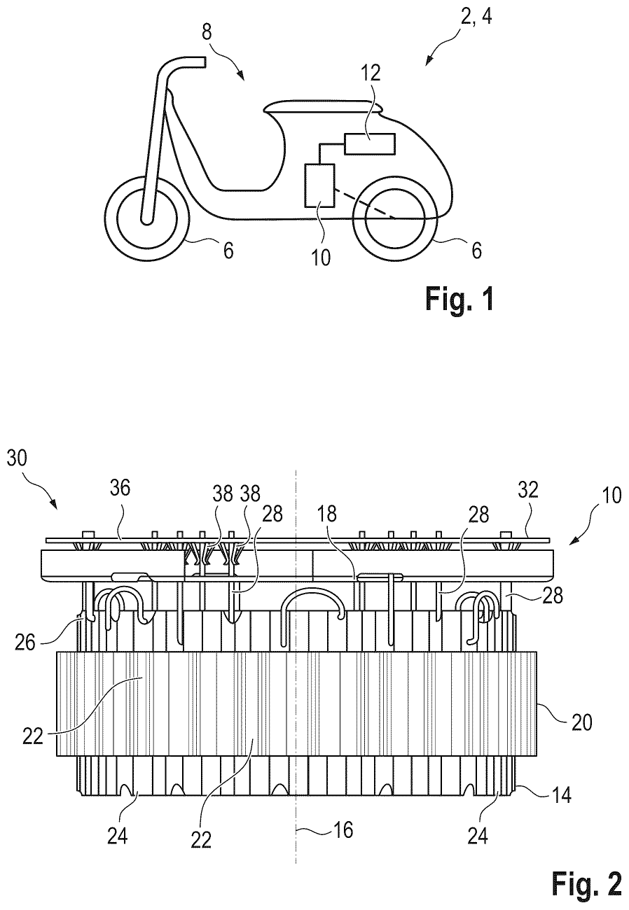

FIG. 1 schematically shows a simplified view of a motor vehicle 2, namely an electric vehicle, in the form of a motor scooter 4. Motor scooter 4 has two wheels 6, one of which is driven with the aid of a main drive 8. Main drive 8 comprises a brushless electric motor 10, which is a brushless DC motor (BLDC). A gearing, which is not illustrated in greater detail and is operatively connected to assigned wheel 6, is driven with the aid of the brushless electric motor 10. Electric motor 10 is operated with the aid of a vehicle electrical system, which is supplied with the aid of an electrical battery 12. An electrical DC voltage of 12 V is provided with the aid of battery 12.

FIG. 2 shows brushless electric motor 10 in a side view, a (motor) housing not being illustrated, which is manufactured from a metal, such as an aluminum. A stator 14 is arranged within the housing, which is provided with a hollow cylindrical design and is arranged around a rotation axis 16. Within stator 14, a rotor, which is not illustrated, is arranged concentrically to rotation axis 16 and is rigidly fastened to a shaft 18, which is also arranged concentrically to rotation axis 16. An air gap is formed between stator 14 and the rotor, so that no direct mechanical contact is present between the rotor and stator 14. Shaft 18 is rotatably supported around rotation axis 16 with the aid of a bearing, which is not illustrated in greater detail and is fastened to the housing.

Stator 14 includes a laminated core 20, with the aid of which multiple teeth 22 are formed. A coil holder 24 is mounted on each tooth 22, which is manufactured from a plastic. Coil holder 24 and/or teeth 22 is/are provided with a circular segment-shaped design and is/are assembled in such a way that the hollow cylinder is formed. Each coil holder 24 is wound with an electrical coil 26.

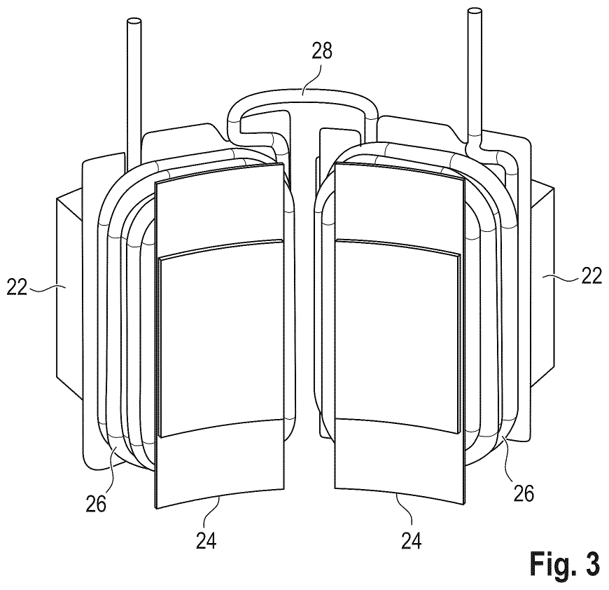

FIG. 3 shows a perspective view of two of electrical coils 26, which are formed from a common enameled wire 28. In other words, the two electrical coils 26 are formed together. For this purpose, they are wound together around assigned coil holder 24. This design is used for all electrical coils 26, so that pairs of electrical coils 26 are presented in each case in this variant of stator 14.

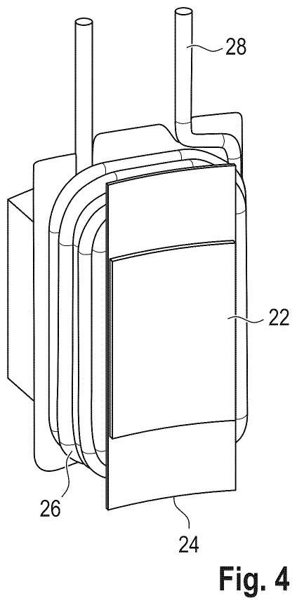

FIG. 4 shows an example. Each electrical coil 26 is formed from particular enameled wire 28, which is wound onto assigned coil holder 24. As a result, electrical coils 26 are initially separate from each other. In other words, electrical coils 26 are formed in this case by means of single tooth winding.

Brushless electric motor 10 further includes an electronic system 30, which has a disk-shaped printed circuit board 32. Printed circuit board 32 is arranged perpendicularly to rotation axis 16, and one of the end faces of hollow cylindrical stator 14 is covered thereby. On the side facing stator 14, multiple receptacles 38 are arranged on a body 36 of printed circuit board 32, which are made from a copper and are designed in the manner of press fits. One of enameled wires 28 is placed into each of receptacles 38, so that electrical coils 26 are electrically contacted with electronic system 30.

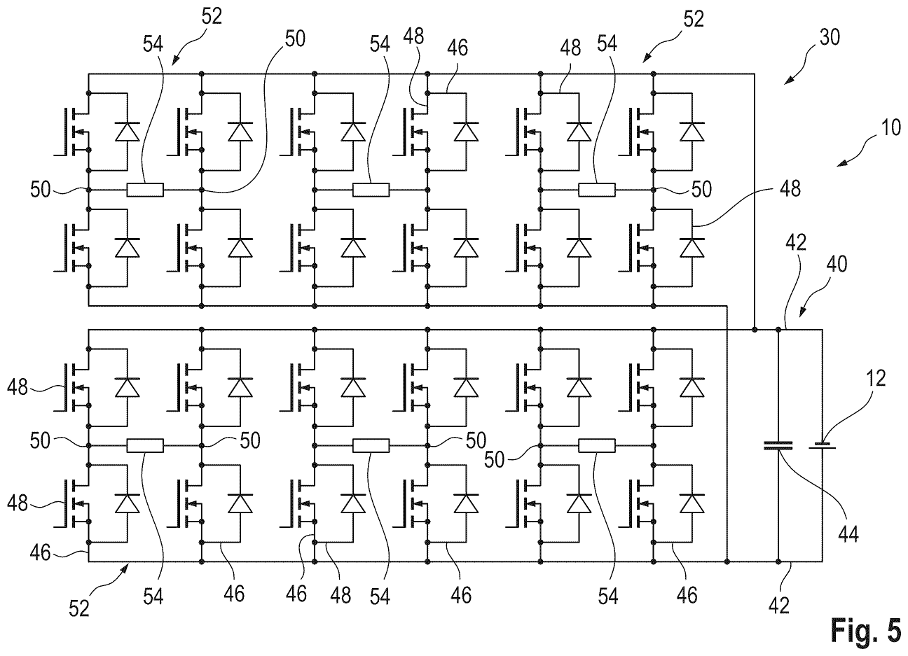

FIG. 5 schematically shows an interconnection of brushless electric motor 10. Electronic system 30 of brushless electric motor 10 has a DC circuit 40, which is electrically contacted with battery 12 in the mounted state, namely via a cable which is not illustrated in greater detail. A terminal is introduced into motor housing for this purpose, into which a corresponding connector of the cable is plugged. The terminal has two contacts, which are assigned to different (electrical) poles 42. During operation, the DC voltage provided with the aid of battery 12 is present between the two poles 42. In summary, electronic system 30 includes DC circuit 40 having the two poles 42.

The two contacts of the terminal are run against printed conductors of printed circuit board 32, which are not illustrated in greater detail, so that the two poles 42 are provided on printed circuit board 32. A capacitor 44 is fastened to body 36 of printed circuit board 32 and electrically contacted with the two poles 42. The electrical voltage present between the two poles 42 is thus stabilized with the aid of capacitor 44.

Electronic system 30 has a total of 12 (twelve) bridge branches 46, which each comprise a series circuit made up of two MOSFETs 48, between which a contact point 50 is formed. Each of bridge branches 46, which are of the same design, is run against one of electric poles 42 on the end side. Bridge branches 46 are thus connected between electrical poles 42. All bridge branches 46 are also connected in parallel to each other as well as in parallel to capacitor 44. One bridge pair 50 is formed in each case with the aid of two of bridge branches 46. As a result, a total of 12 bridge branches 46 and 6 (six) bridge pairs 52 are present.

MOSFETs 48 are components of printed circuit board 32 and are fastened to body 36 and electrically contacted therewith. The interconnection of MOSFETs 48 to each other, namely corresponding printed conductors, is also implemented with the aid of printed circuit board 46. Bridge branches 46 are thus provided with the aid of printed circuit board 32. Contact points 50 are at least partially formed with the aid of receptacles 38, with which electrical coils 26 are contacted.

Electrical coils 26, the 12 (twelve) electrical coils 26 in the illustrated example, are distributed to a total of 6 (six) phases 54. Two of electrical coils 26 are thus assigned to each of phases 54 in each case. To the extent that the variant illustrated in FIG. 3 is used, all electrical coils 26 of each of phases 54 are formed from particular common enameled wire 28.

Each phase 54 is thus run against one of contact points 50 on the end side. In each case, each phase 54 is connected between the two bridge branches 46 of one of bridge pairs 52. As a result, only the electrical current used for particular phase 54 is carried with the aid of each of bridge branches 46, so that a load is reduced. An interconnecting ring is also not necessary, and no common star point or the like is also needed for phases 54.

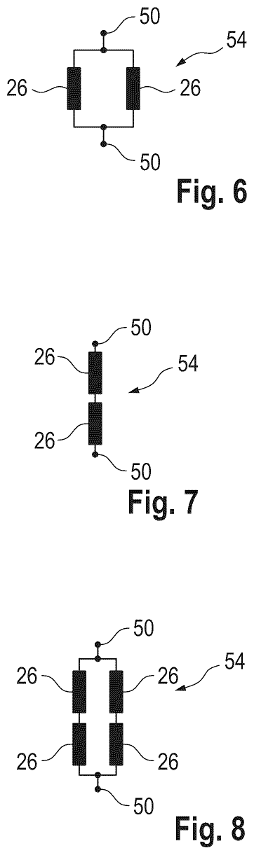

FIG. 6 schematically shows an example of phases 54, this example then being used for all phases 54 of electric motor 10. The two assigned electrical coils 26 are connected in parallel to each other, so that each of electrical coils 26 is electrically contacted in each case to assigned contact points 50. If the variant of electrical coils 26 illustrated in FIG. 3 is used, the portion of enameled wire 28 present between the two electrical coils 26 is electrically contacted to one of receptacles 38. In this example, the electrical current carried by each of electrical coils 26 is comparatively low, so that a load is decreased.

FIG. 7 shows an example for phases 54, which is then used for entire stator 14. The two assigned electrical coils 26 are electrically connected in series between the two contact points 50, which makes the electrical connection to receptacles 38 easier.

FIG. 8 shows an example for phases 54. In each case, four of electrical coils 26 are assigned in each case to each phase therein, two series circuits being formed from two of electrical coils 26. The two series circuits are connected in parallel to each other between assigned contact points 50. In this example, the number of bridge pairs 52 is reduced and is, in particular, exactly 3 (three).

The invention is not limited to the exemplary embodiments described above. Instead, other variants of the invention may be derived therefrom by those skilled in the art without departing from the subject matter of the invention. Moreover, in particular, all individual features described in connection with the individual exemplary embodiments may also be otherwise combined with each other without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A brushless electric motor for a motor vehicle, the motor comprising:
a stator that has at least two electrical coils, which are distributed to multiple phases; and
an electronic system, which has a DC circuit with two electrical poles, between which a plurality of bridge branches are connected, two bridge branches in each case forming one bridge pair, and each phase being connected in each case between one of the bridge branches of one of the bridge pairs.

2. The brushless electric motor according to claim 1, wherein a portion of the electrical coils of each phase are formed from a common enameled wire.

3. The brushless electric motor according to claim 1, wherein the electrical coils are formed by single tooth winding.

4. The brushless electric motor according to claim 1, wherein the number of phases is equal to 6, the number of electrical coils is equal to 12, and the number of bridge branches being equal to 12.

5. The brushless electric motor according to claim 1, wherein each bridge branch has a series circuit made up of two MOSFETs, which is run in each case against one of the electrical poles on an end side, and wherein a contact point is formed between the two MOSFETs, against which the phase assigned in each case is run on the end side.

6. The brushless electric motor according to claim 1, wherein the stator is hollow cylindrically, and wherein an end face is covered by a printed circuit board of the electronic system, with the aid of which the bridge circuits are provided.

7. A motor scooter comprising a main drive that comprises a brushless electric motor according to claim 1.
